(19) United States
(12) Patent Application Publication
(10) Pub. No.: US 2005/0141061 A1
(43) Pub. Date: Jun. 30, 2005

(54) Driving method for solid-state imaging device

(76) Inventor: Kiyoshi Nagata, Fukuoka (JP)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/006,111

(22) Filed: Dec. 7, 2004

(30) Foreign Application Priority Data
Dec. 12, 2003 (JP) JP2003-414418

(51) Int. Cl. H04N 9/09

(52) U.S. Cl. 358/513

(57) ABSTRACT

There is provided a driving method for a solid-state imaging apparatus that has plural registers transferring signal charges captured in sensor array rows and a multiplexing section transferring the signal charges, which are individually transferred thereto from the plural registers, toward a charge-voltage converter. Further, this method includes a mode in which the signal charges transferred from the plural registers are mixed and swept out by the multiplexing section.

### CROSS REFERENCES TO RELATED APPLICATIONS

The present invention claims priority to its priority document No. 2003-414418 filed in the Japanese Patent Office on Dec. 12, 2003, the entire contents of which being incorporated by reference herein.

### BACKGROUND OF THE INVENTION

1. Field of the Invention

The present invention relates to a driving method for a solid-state imaging device. More particularly, the present invention relates to a method for driving a solid-state imaging device, according to which signal charges transferred from plural registers are mixed and swept out, thereby to enable high speed sweeping of signal charges without adversely affecting image signals.

2. Description of the Related Art

An image input apparatus applied to a scanner or a copier employs a solid-state imaging device having linear sensors, and inputs images by scanning read positions of this solid-state imaging device.

In recent years, there have been strong demands for enhancement of read resolution and increase in read rate. A linear sensor dealing with the demands by using plural sensor rows has been developed. For example, as shown in FIG. 3, a solid-state imaging device has a solid-state imaging device having a main line sensor row 102 in which plural sensor sections 101 are arranged, a sub-line sensor row 103 in which plural sensor sections are arranged by being shifted by a half-pitch thereof, and plural signal charge storage sections 104 for storing signal charges obtained from the sensor sections of the main line sensor row; and has a first register 105 for transferring the stored signal charge between the signal charge storage sections by changing potentials at these signal charge storage sections, and plural signal charge storage sections for storing signal charges obtained from the sensor sections of the sub-line sensor row; and has a second register 106 for horizontally transferring stored signal charges between the signal charge storage sections by changing potentials at these signal charge storage sections, and plural signal charge storage sections for storing signal charges transferred from the first register and the second register; and has a multiplexing section 108 for transferring stored signal charges between the signal charge storage sections in the direction of a charge-voltage conversion means 107 by changing potentials at these signal charge storage sections. This imaging device is adapted to multiplex the signal charge captured by the main line sensor row and the signal charge captured by the sub-line sensor row to alternately output the signal charges.

In a case where high-resolution output signals are obtained by the solid-state imaging device configured as shown in FIG. 3 (in a case where signal charges stored in the main line sensor row and the sub-line sensor row are outputted), a driving pulse is provided to a signal charge storage section (1) designated by reference character “a” in FIG. 3 with timing designated by reference character φ1 in FIG. 4A. A driving pulse is provided to a signal charge storage section (2) designated by reference character “b” in FIG. 3 with timing designated by reference character φ2 in FIG. 4A. A driving pulse is provided to a signal charge storage section (3) designated by reference character “c” in FIG. 3 with timing designated by reference character φ3 in FIG. 4A. A driving pulse is provided to a signal charge storage section (4) designated by reference character “d” in FIG. 3 with timing designated by reference character φ4 in FIG. 4A. Additionally, a driving pulse is provided to a signal charge storage section (5) designated by reference character “e” in FIG. 3 with timing designated by reference character φ1L in FIG. 4A. Consequently, the signal charges captured in the main line sensor row and the sub-line sensor row are transferred to the multiplexing section by the first register and the second register. Then, the signal charges are transferred by the multiplexing section toward the charge-voltage conversion means. Thus, output signals are obtained from an output section.

On the other hand, in a case where low-resolution output signals are obtained by the solid-state imaging device configured as shown in FIG. 3 (in a case where only signal charges stored in the main line sensor row are outputted), a driving pulse is provided to a signal charge storage section (1) in FIG. 3 with timing designated by reference character φ1 in FIG. 4B. A driving pulse is provided to a signal charge storage section (2) with timing designated by reference character φ2 in FIG. 4B. A driving pulse is provided to a signal charge storage section (3) with timing designated by reference character φ3 in FIG. 4B. A driving pulse is provided to a signal charge storage section (4) with timing designated by reference character φ4 in FIG. 4B. Additionally, a driving pulse is provided to a signal charge storage section (5) with timing designated by reference character φ1L in FIG. 4B. Consequently, the signal charges captured in the sub-line sensor row are swept out to an overflow drain section 109, while only the signal charges captured in the main line sensor row are transferred to the multiplexing section by the first register and the second register. Then, the signal charges are transferred by the multiplexing section toward the charge-voltage conversion means. Thus, low-resolution signals are outputted from the output section.

Meanwhile, recently, it has sometimes been required to extract only an image of a predetermined region from a captured image, for example, extract an image of a predetermined region from a panoramic image, as described in Japanese Patent Application Publication H11-136584. That is, it has sometime been required to extract only an image of a reading region, which is designated by reference character B in FIG. 5, from an image region of one line, which is designated by reference character A in FIG. 5.

Further, in a case where only the image of the reading region is extracted, it is necessary to sweep away signal charges associated with a precedent region, which is designated by reference character C in FIG. 5, and those associated with a subsequent region, which is designated by reference character D, of the reading region.

As a method of sweeping away signals charges, there has been a method of providing a driving pulse to each of signal charge storage sections (1) to (5) with the timing similar to that shown in FIG. 4A in signal-charge sweeping modes designated by reference characters C and D, as shown in FIG. 6, and transferring signal charges, which are stored in a main line sensor row and a sub-line sensor row, by a multiplexing section, and thereafter sweeping away unnecessary ones of the transferred signal charges.

FIG. 6A illustrates clock timings, at which driving pulses are respectively provided, in the case of obtaining high-resolution output signals. FIG. 6B illustrates clock timings, at which driving pulses are respectively provided, in the case of obtaining low-resolution output signals.

Further, as another method of sweeping away signals charges, there has been a method of providing a driving pulse to each of signal charge storage sections (1) to (5) with the timing similar to that shown in FIG. 4B in signal-charge sweeping modes designated by reference characters C and D, as shown in FIG. 7, and sweeping away signal charges stored in a sub-line sensor row, and transferring only signal charges, which are stored in a main line sensor row, by a multiplexing section, and thereafter sweeping away unnecessary one of the transferred signal charges (for example, see Japanese Patent Application Publication 2002-330359).

FIG. 7A illustrates clock timings, at which driving pulses are respectively provided, in the case of obtaining high-resolution output signals. FIG. 7B illustrates clock timings, at which driving pulses are respectively provided, in the case of obtaining low-resolution output signals.

### SUMMARY OF THE INVENTION

However, it is necessary for the former method to operate the signal charge storage sections so that the frequency of driving pulses provided to the signal charge storage sections (3) and (4) are twice the frequency of driving pulses provided to the signal charge storage sections (1), (2) and (5). Thus, typically, the signal charge sweeping rate (or the operating frequency) of the signal charge sweeping mode is determined by the maximum frequency of the pulses that can be provided to the signal charge storage sections (3) and (4).

Therefore, a high-speed sweeping operation cannot be performed at the operating frequency is higher than the maximum frequency of the pulses provided with each of the timing φ3 and the timing φ4.

On the other hand, it is sufficient for the latter method to operate the signal charge storage sections so that the frequency of driving pulses provided to the signal charge storage sections (3) and (4) are equal to the frequency of driving pulses provided to the signal charge storage sections (1) and (2). Thus, the problem of high-speed sweeping of signal charges, which occurs in the former method, does not occur in the latter method. However, in a case where signal charges stored in the sub-line row are not quickly swept out when swept out to the overflow drain section, the signal charges to be swept out to the overflow drain section are temporarily stored in the signal charge storage section (2), which is designated by reference character “x” in FIG. 3 and connected to the overflow drain section. In a case where the signal charge sweeping mode, in which the signal charges stored in the sub-line sensor row are swept out to the overflow drain section as unnecessary signal charges, is changed to a mode, in which the signal charges stored in the sub-line sensor line are outputted as unnecessary signal charges, in this state, the signal charges that should originally be swept out to the overflow drain section are outputted together with necessary signal charges from the output section and may adversely affect image signals.

The present invention is made in view of the above-mentioned respects. It is desirable to provide a driving method for a solid-state imaging apparatus, which enables high-speed sweeping of signal charges without adversely affecting image signals.

According to an embodiment of the present invention, there is provided a driving method for a solid-state imaging apparatus that has plural registers transferring signal charges captured in sensor array rows and a multiplexing section transferring the signal charges, which are individually transferred thereto from the plural registers, toward the charge-voltage conversion means. The present method includes a mode in which the signal charges transferred from the plural registers are mixed and swept out by the multiplexing section.

In the present embodiment, the signal charges transferred from the plural registers are mixed and swept out by the multiplexing section. Accordingly, reduction in the operating frequency, which is required for clock pulses applied to the signal charge storage sections of the multiplexing section if the signal charges are swept out, can be achieved.

As described above, the driving method for a solid-state imaging device according to the present embodiment can realize the high-speed sweeping of signal charges. That is, the reduction in the operating frequency, which is required of clock pulses applied to the signal charge storage sections of the multiplexing section if the signal charges are swept out, can be achieved. Accordingly, in the case of applying pulses having the same frequency to the signal charge storage sections of the multiplexing section, the sweeping of the signal charges can be performed in a shorter period of time.

Furthermore, according to the present embodiment, the signal charges are not swept out to the overflow drain section. This solves or alleviates the problem of that signal charges to be swept to the overflow drain. Accordingly, the signal charges to be swept to the overflow drain section do not adversely affect image signals.

In other words, the driving method for a solid-state imaging device according to the present embodiment enables a high-speed sweeping of signal charges without adversely affecting image signals.

### BRIEF DESCRIPTION OF THE DRAWINGS

The above and other objects, features and advantages of the present invention will become more apparent from the following description of the presently exemplary embodiment of the invention taken in conjunction with the accompanying drawings, in which:

FIG. 1 illustrates clock timings, at which driving pulses are respectively provided, in an example of a driving method for a CCD linear sensor, to which the present embodiment is applied;

FIG. 2 illustrates clock timings, at which driving pulses are respectively provided, in another example of a driving method for a CCD linear sensor, to which the present embodiment is applied;

FIG. 3 is a schematic diagram illustrating a CCD linear sensor;

FIG. 4 illustrates clock timings, at which driving pulses are respectively provided, for obtaining (high-resolution and low-resolution) output signals from the CCD linear sensor;

FIG. 5 is a schematic diagram illustrating extraction of an image;

FIG. 6 illustrates clock timings, at which driving pulses are respectively provided, according to a signal charge sweeping method (1); and

FIG. 7 illustrates clock timings, at which driving pulses are respectively provided, according to a signal charge sweeping method (2).

### DETAILED DESCRIPTION OF THE EMBODIMENTS

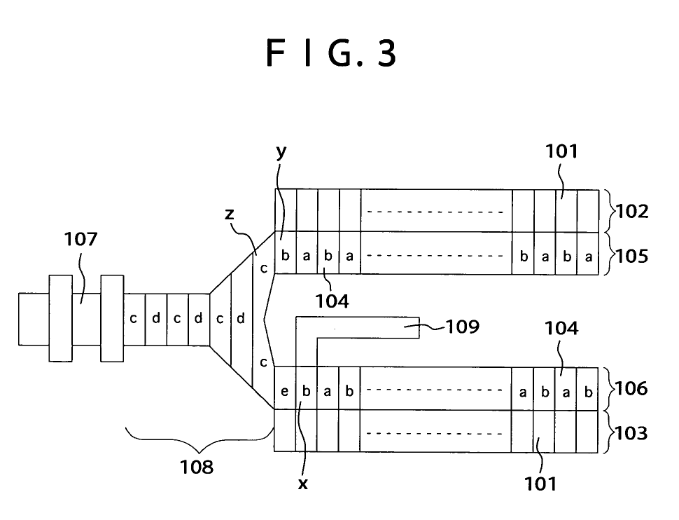

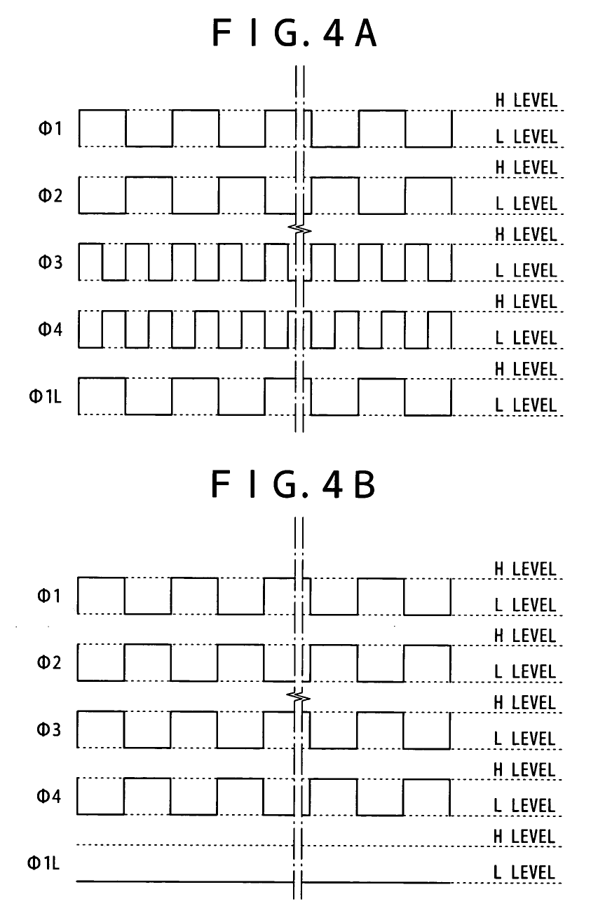

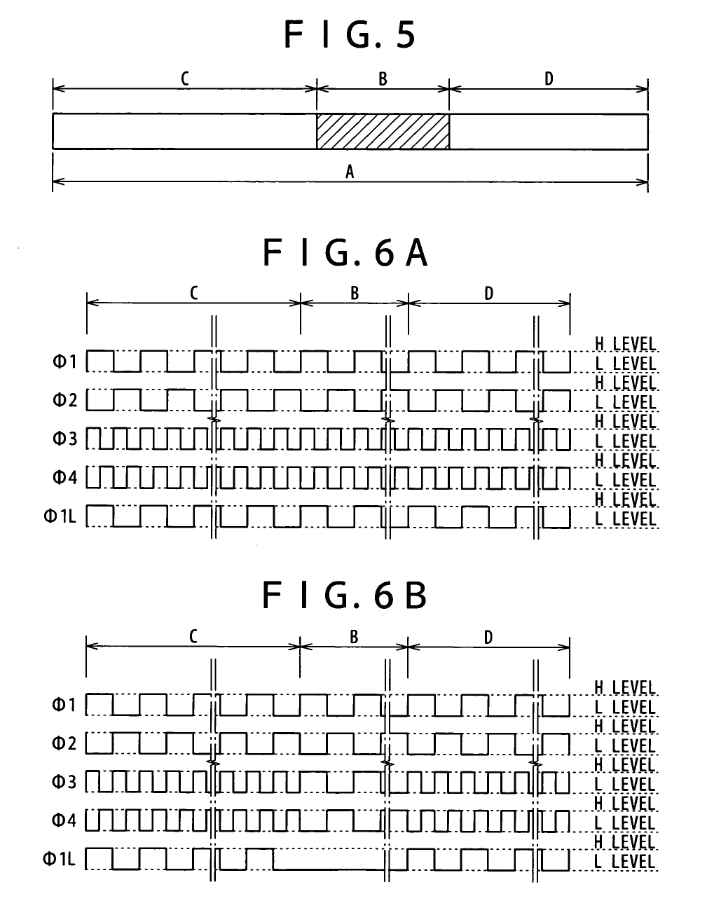

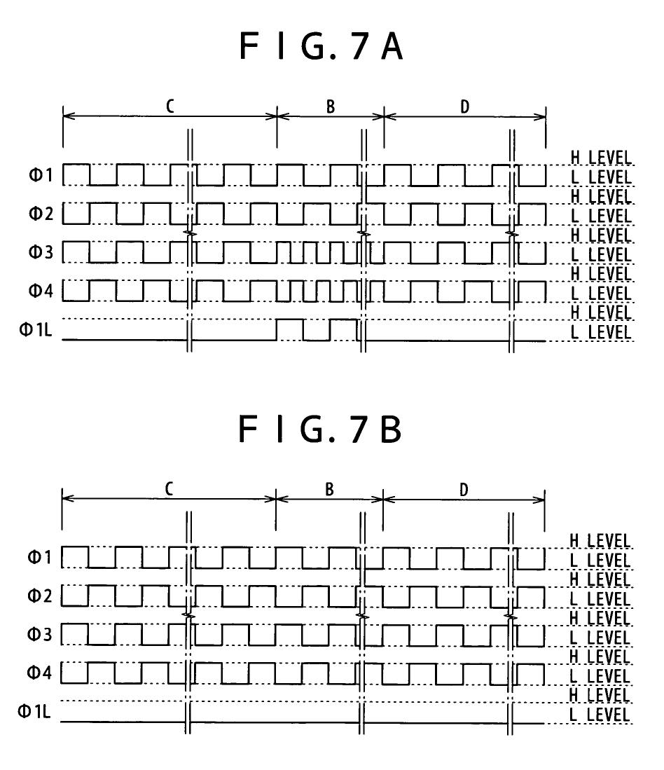

Hereinafter, an embodiment of the present invention is described by referring to the accompanying drawings. The following description of the present embodiment describes a driving method for a CCD linear sensor having a structure as shown in FIG. 3.

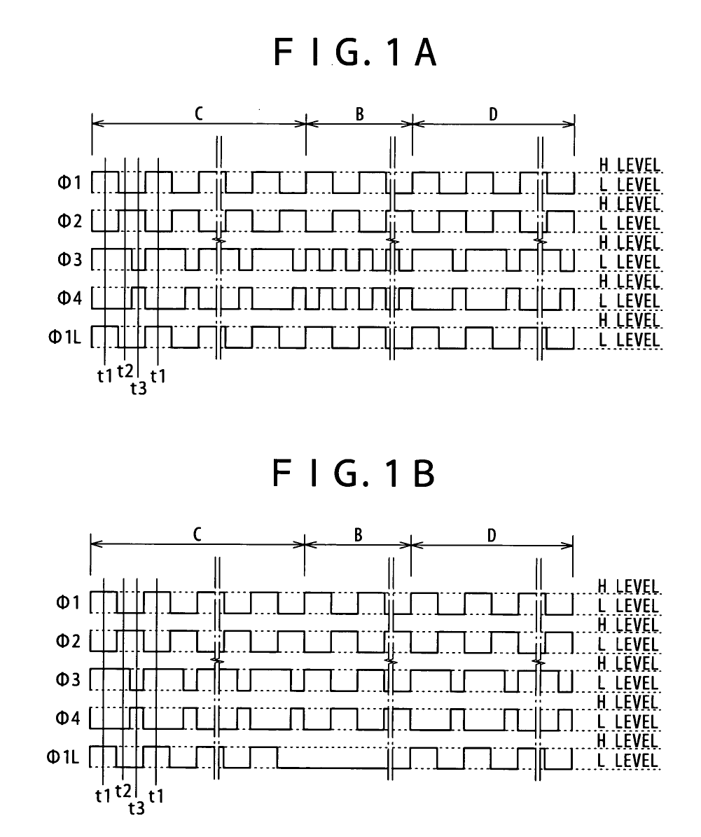

FIG. 1 illustrates clock timings, at which driving pulses are respectively provided, in an example of a driving method for a CCD linear sensor, to which the present embodiment is applied. In FIG. 1, reference character φ1 indicates timing with which driving pulses are provided to the signal charge storage section (1). In FIG. 1, reference character φ2 indicates timing with which driving pulses are provided to the signal charge storage section (2). In FIG. 1, reference character φ3 indicates timing with which driving pulses are provided to the signal charge storage section (3). In FIG. 1, reference character φ4 indicates timing with which driving pulses are provided to the signal charge storage section (4). In FIG. 1, reference character φ1L indicates timing with which driving pulses are provided to the signal charge storage section (5). FIG. 1A illustrates clock timings, at which the driving pulses are respectively provided, in the case of obtaining high-resolution output signals. FIG. 1B illustrates clock timings, at which the driving pulses are respectively provided, in the case of obtaining low-resolution output signals.

In the case of an example of the driving method for a CCD linear sensor, at a time t1, the levels of signals φ1, φ1L, and φ3 are set to be a high level (hereunder referred to as H-level), while the levels of signals φ2, and φ4 are set to be a low level (hereunder referred to as L-level). Thus, signal charges stored in the signal charge storage sections (2) and (4) are transferred to the adjacent signal charge storage sections. That is, signal charges stored in the signal charge storage section (2) designated by reference character y in FIG. 3 are transferred to the signal charge storage section (3) designated by reference character z in FIG. 3. Signal charges stored in the signal charge storage section (2) designated by reference character x in FIG. 3 are transferred to the signal charge storage section (5). Signal charges stored in the other signal charge storage sections (2) are transferred to the signal charge storage section (1). Further, signal charges stored in the signal charge are transferred to the signal charge storage section (3).

Subsequently, at a time t2, the levels of signals φ1 and φ1L are set to be L-level, while the level of a signal φ2 is set to be H-level. Thus, signal charges stored in the signal charge storage sections (1) and (5) are transferred to the adjacent signal charge storage sections. That is, signal charges stored in the signal charge storage section (1) are transferred to the signal charge storage section (2). Signal charges stored in the signal charge storage section (5) are transferred to the signal charge storage section (3) designated by reference character z in FIG. 3.

Therefore, at the time t2, the signal charges stored in the signal charge storage section (2) designated by reference character y in FIG. 3 and those stored in the signal charge storage section (5) are mixed in the signal charge storage section designated by reference character z in FIG. 3.

Subsequently, at a time t3, the level of a signal φ3 is set to be L-level, while the level of a signal φ4 is set to be H-level. Thus, the signal charges stored in the signal charge storage (3) are transferred to the adjacent signal charge storage section. That is, the signal charges stored in the signal charge storage section (3) are transferred to the signal charge storage section (4).

Thereafter, the levels of signals φ1 and φ1L are set to be H-level, while the levels of signals φ2 and φ4 are set to be L-level. Thus, the clock timing coincides with the time t1. Operations as performed from the time t1 to the time t3 are repeated. Consequently, the signal charge stored in one of the signal charge storage sections, which constitute the first register, and the signal charge stored in one of the signal charge storage sections, which constitute the second register, are mixed and transferred by the signal charge storage section constituting the multiplexing section.

In the above-mentioned example of the driving method for the CCD linear sensor, to which the present embodiment is applied, the signal charges are mixed and transferred by repeating operations as performed from the time t1 to the time t3 in the signal charge sweeping mode designated by the reference characters C and D in FIG. 1. Thus, the high-speed sweeping of signal charges can be achieved.

Further, the signal charges are not swept out to the overflow drain section. Thus, even immediately after the signal charge sweeping mode designated by reference character C in FIG. 1A is changed to the signal charge reading mode, in which the signal charges stored in the main line sensor row and the sub-line sensor row are read out, unnecessary charges to be swept out to the overflow drain section are outputted from the output portion and do not adversely affect image signals.

In the case where low-resolution output signals are obtained, as illustrated in FIG. 1B, signal charges stored in the sub-line sensor row are not read out of the output section originally. Thus, unnecessary charges to be swept out to the overflow drain section do not adversely affect image signals.

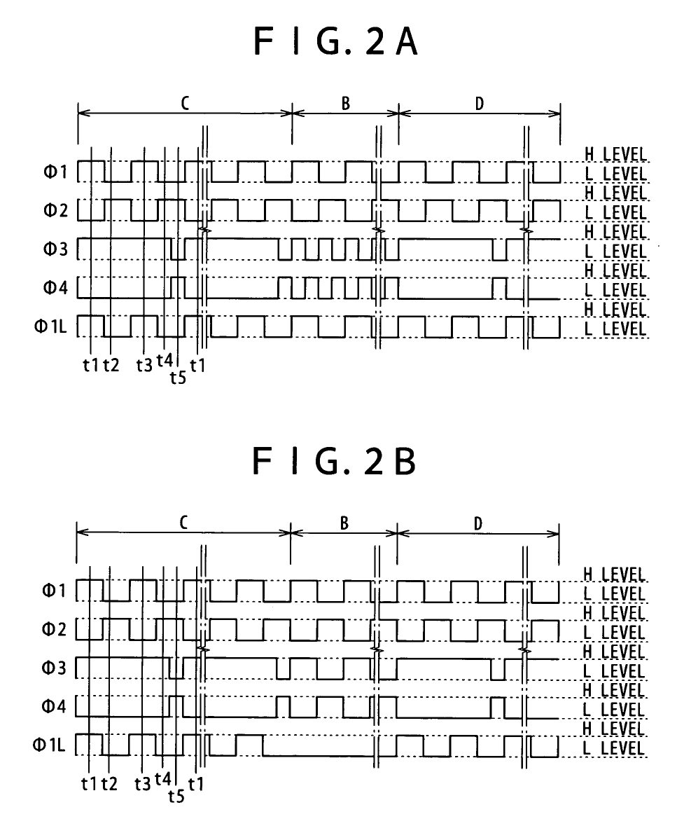

FIG. 2 illustrates clock timings, at which driving pulses are respectively provided, in another example of the driving method for a CCD linear sensor, to which the present embodiment is applied. In FIG. 2, reference character φ1 indicates timing with which driving pulses are provided to the signal charge storage section (1). In FIG. 2, reference character φ2 indicates timing with which driving pulses are provided to the signal charge storage section (2). In FIG. 2, reference character φ3 indicates timing with which driving pulses are provided to the signal charge storage section (3). In FIG. 2, reference character φ4 indicates timing with which driving pulses are provided to the signal charge storage section (4). In FIG. 2, reference character φ1L indicates timing with which driving pulses are provided to the signal charge storage section (5). FIG. 2A illustrates clock timings, at which the driving pulses are respectively provided, in the case of obtaining high-resolution output signals. FIG. 2B illustrates clock timings, at which the driving pulses are respectively provided, in the case of obtaining low-resolution output signals.

In another example of the driving method for the CCD linear sensor, at a time t1, the levels of signals φ1, φ1L, and φ3 are set to be H-level, while the levels of signals φ2, and φ4 are set to be L-level. Thus, signal charges stored in the signal charge storage sections (2) and (4) are transferred to the adjacent signal charge storage sections, similarly to the operation at the time t1 in the former example of the driving method for the CCD linear sensor, to which the present embodiment is applied.

Subsequently, at a time t2, the levels of signals φ1 and φ1L are set to be L-level, while the level of a signal φ2 is set to be H-level. Thus, signal charges stored in the signal charge storage sections (1) and (5) are transferred to the adjacent signal charge storage sections, similarly to the operation at the time t2 in the above-described example of the driving method for the CCD linear sensor, to which the present embodiment is applied.

Subsequently, at a time t3, the levels of signals φ1 and φ1L are set to be H-level, while the levels of signals φ2 and φ4 are set to be L-level. Thus, the clock timing coincides with the time t1, so that signal charges stored in the signal charge storage sections (2) and (4) are transferred to the adjacent signal charge storage sections.

Subsequently, at a time t4, the levels of signals φ1 and φ1L are set to be L-level, while the level of a signal φ2 is set to be H-level. Thus, the clock timing coincides with the time t2, so that signal charges stored in the signal charge storage sections (1) and (5) are transferred to the adjacent signal charge storage sections.

Subsequently, at a time t5, the level of a signal φ3 is set to be L-level, while the level of a signal φ4 is set to be H-level. Thus, signal charges stored in the signal charge storage section (3) are transferred to the adjacent signal charge storage sections, similarly to the operation at the time t3 in the former example of the driving method for the CCD linear sensor to which the present embodiment is applied.

Thereafter, the levels of signals φ1, φ1L and φ3 are set to be H-level, while the levels of signals φ2 and φ4 are set to be L-level. Thus, the clock timing coincides with the time t1. Operations as performed from the time t1 to the time t5 are repeated. Consequently, the signal charges stored in two of the signal charge storage sections, which constitute the first register, and the signal charges stored in two of the signal charge storage sections, which constitute the second register, are mixed and transferred by the signal charge storage section constituting the multiplexing section. After transferred, the signal charges are finally swept out to a drain (not shown) usually disposed downstream of a charge-voltage converter 107.

In the present example of the driving method for the CCD linear sensor, to which the present embodiment is applied, the signal charges are mixed and transferred by repeating operations as performed from the time t1 to the time t5 in the signal charge sweeping mode designated by the reference characters C and D in FIG. 2. Thus, the high-speed sweeping of signal charges can be achieved.

Further, this example is similar to the former example of the driving method for a CCD linear sensor in that the signal charges are not swept out to the overflow drain section.

The description of the embodiments has described examples, in which the signal charges stored in the four signal charge storage sections are mixed, by way of example. However, as long as the signal charge storage section (3) and the signal charge storage section (4) have sufficient signal charge storing capability, a larger amount of signal charges can be mixed by increasing the length of a time period, in which the level of the signal φ3 is set to be H-level and which the level of the signal φ4 is set to be L-level. In this case, the sweeping of signal charges can be performed at a higher speed.

Further, the description of the embodiments has described the CCD linear sensor, which has the main line sensor row and the sub-line sensor row and can obtain high-resolution outputs by outputting signal charges stored in the main line sensor row and the sub-line sensor row and which can obtain low-resolution outputs by sweeping away the signal charges stored in the sub-line sensor row and outputting only the signal charges stored in the main line sensor row, by way of example. Thus, the description of the embodiments has been described by assuming that the overflow drain section is formed in the CCD linear sensor. However, a CCD linear sensor, which is assumed to have a main line sensor row and a sub-line sensor row so as to enhance read resolution and also assumed to output signal charges stored in the main line sensor and the sub-line sensor at all times, can be conceived. The driving method for this CCD linear sensor does not need forming an overflow drain section therein.

In other words, it is necessary for realizing high-speed sweeping by the signal charge sweeping method of related art to sweep away signal charges stored in the sub-line sensor row to the overflow drain section. Even in the case of using the CCD linear sensor assumed to output signal charges stored in the main line sensor row and the sub-line sensor row, it is necessary for high-speed sweeping of signal charges to form an overflow drain section. However, according to the driving methods for the CCD linear sensor, to which the present embodiment is applied, the sweeping of the signal charges to the overflow drain section is not performed when the high-speed sweeping of the signal charges is conducted. Thus, in the case that this method uses the CCD linear sensor, which is assumed to output signal charges stored in the main line sensor row and the sub-line sensor row at all times, it is unnecessary to form the overflow drain section. This simplifies the structure of the CCD linear sensor.

Furthermore, the above description of the embodiments describes the CCD linear sensor, which has the two registers, by way of example. However, the number of registers formed in the CCD linear sensor is not necessarily limited to 2.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

1. A driving method for a solid-state imaging apparatus having:
a plurality of registers for transferring signal charges captured in sensor array rows; and
a multiplexing section for transferring signal charges, individually transferred thereto from the plurality of registers, toward a charge-voltage conversion means,
the driving method comprising:
a mode in which signal charges transferred from the plurality of registers are mixed and swept out by the multiplexing section.

2. The driving method for a solid-state imaging apparatus according to claim 1, wherein
the multiplexing section is driven at the same frequency as that of the plurality of registers in the mode in which signal charges transferred from the plurality of registers are mixed and swept out by the multiplexing section.
